(19) United States
(12) Patent Application Publication
(10) Pub. No.: US 2014/0214711 A1
(43) Pub. Date: Jul. 31, 2014

(54) INTELLIGENT JOB RECRUITMENT SYSTEM AND METHOD

(71) Applicant: Arik Filstein, Herzila (IL)

(72) Inventor: Arik Filstein, Herzila (IL)

(73) Assignee: Jobookit Technologies Ltd., Ra'anana (IL)

(21) Appl. No.: 14/241,822

(22) PCT Filed: Aug. 28, 2012
(86) PCT No.: PCT/IL12/00322

§ 371 Date: Feb. 27, 2014

Related U.S. Application Data
(60) Provisional application No. 61/528,296, filed on Aug. 29, 2011.

(51) Int. Cl. G06Q 10/10

(52) U.S. Cl. CPC G06Q 10/1053
USPC 705/321

(57) ABSTRACT

A computer-implemented method for sorting candidates according to their relevance to a job query, according to which a website through which a search for candidates can be executed is provided and index information related to each of the candidates is stored in a candidate profile. Upon supplying a search query that includes keywords in the website, search engine is queried with the supplied query. A reporting engine is used for notifying whenever the search query has been issued. Then a full search query is automatically built according to the search query by boosting the keywords and matching is done between the full search query and the stored candidates' profiles. Listing of all matching candidates sorted is displayed according to their relevance to the full search query and whenever a candidate profile is selected from the listing, a notification is sent to the reporting engine for updating the overall score of the selected candidate.

### FIELD OF THE INVENTION

The present invention relates to the field of on-line job recruiter. More particularly, the invention relates to a method and system for providing an intelligent job hunt based on web behavior of job hunters and employers.

### BACKGROUND OF THE INVENTION

Finding a job can be a difficult and time-consuming task. Career websites or job boards allow recruiters to post job listings that can be searched by job seekers using text-based queries. However, using such websites to search for a job can be overwhelming because such websites may list thousands of job openings at any given time. Of the large number of job openings, only a small percentage will likely be relevant to a particular individual's career goals. Furthermore, the list of job openings may not be presented in a manner that allows the individual to efficiently navigate the results and determine which job listings are most relevant. Moreover, conventional job hunting websites fail to provide any guidance to assist an individual in obtaining a job that actually matches the individual's career goals. Therefore, an improved system and method for job hunting is needed.

Employers may invest a great deal of time and money into recruiting. They may spend this time and money reviewing application materials such as resumes and cover letters and may not have all the relevant information about candidates that they need. For at least these reasons, employers may not be as efficient or accurate in matching candidates to open positions as they could be.

Further, candidates may become frustrated while searching for positions.

While they may submit resumes and cover letters to employers, they may still be unable to convey relevant information to employers regarding their skill sets, behavioral background, and other candidate information. For at least these reasons, candidates may miss employment opportunities or may not be considered for positions that they may be qualified for.

Accordingly, employers may need an application that allows them to collect and view relevant information about candidates regarding their skill sets, behavioral background, and other candidate information. Additionally, candidates may need an application to assist them in acquiring a position by matching their skill sets, behavioral background, and other candidate information with employers and open positions. Also, employers may need to reduce the cost and time for acquiring human resources.

It is an object of the present invention to provide a system which is capable of matching between employers and job seekers, yielding more opportunities, with utmost relevancy, everywhere around the world and in any language.

Other objects and advantages of the invention will become apparent as the description proceeds.

### SUMMARY OF THE INVENTION

The present invention relates to a computer-implemented method for sorting candidates according to their relevance to a job query, the method comprising the steps of: a) providing a website through which a search for candidates can be executed; b) storing in a candidate profile index information related to each of said candidates; c) upon supplying a search query in said website, search engine is queried with said supplied query, wherein said query includes one or more keywords; d) providing a reporting engine for notifying whenever said search query has been issued; e) automatically building a full search query according to said search query by boosting said keywords; f) Matching between said full search query and said stored candidates' profiles; g) displaying, listing of all matching candidates sorted according to their relevance to said full search query; and h) whenever selecting a candidate profile from said listing, sending a notification to the reporting engine for updating the overall score of said selected candidate.

According to an embodiment of the present invention, the computer-implemented method wherein the boosting of the keywords is done by a semantic engine, which used for improving the search results by understanding searcher intent and the contextual meaning of the search query, thereby generating more relevant results.

According to an embodiment of the present invention, the computer-implemented method further comprises updating the overall score of each candidate according to chronological changes that occurs with respect to each candidate's profile using an information update service(s).

According to an embodiment of the present invention, the search engine queries the candidate profile index using data selected from the group consisting of textual query related to the job title or field, codes representative of the job groups, geographic area, or combination thereof. Additionally, the search query may limit the search results to candidates in a particular geographic area, wherein the search engine can automatically determine one or more geographic areas of interest to the searcher based on information in the candidate's profile.

According to an embodiment of the present invention, the search engine maps the search query to an entry in the candidate's profile index using a pattern matching or word matching algorithm, which is capable of outputting or providing a matching score representing the strength of the match between a particular built job query and an entry in said candidate profile index.

According to an embodiment of the present invention, the search engine sorts the search results according to relevancy score being currently calculated for a specific search query, wherein said relevancy score is being calculated according to one or more relevancy parameters, thus the overall score for each candidate listing in said results is determined by weighting and summing the relevancy scores, and wherein the weights of the relevancy scores depend on the particular job being queried. Preferably, at least on of the relevancy parameters is based on the overall score of each candidate which reflects the web behavior of other job recruiter with respect to a specific candidate profile, whether said specific candidate's profile viewed and/or selected by other job recruiter. According to an embodiment of the present invention, each of the relevancy scores is calculated according to each specific search query, thus a specific candidate could be sorted differently, for each specific job query. According to different category filters, any number of relevancy scores can be computed, each associated with a different target job. Additionally, different target job criteria can be used depending on the particular goals of the job query.

According to an embodiment of the present invention, the computer-implemented method further comprises determining a probability of the candidate being qualified for a particular job opening and presents the probability together with the search results.

According to an embodiment of the present invention, the computer-implemented method further comprises analyzing candidate interactions from other sources using a dedicated application. For example, the dedicated application can be an integrated web-based application for social network, thereby allowing said system to output search results to a social network and/or obtain candidate information from said social networks.

The present invention further relates to a system for sorting candidates according to their relevance to a job query, comprising: a) a web server for providing a website through which a search for candidates can be executed; b) a candidate profile index connected to said web server for storing information related to each of said candidates; c) a search engine for analyzing a search query provided through said website, wherein said search query includes one or more keywords from which said search engine automatically builds a full search query according to said search query by boosting said keywords, and for matching between said full search query and said stored candidates' profiles, and accordingly for generating a listing of all matching candidates sorted according to their relevance to said full search query; and d) a reporting engine for updating the overall score of each candidate whenever a candidate profile is selected from said listing.

According to an embodiment of the present invention, the system further comprises a semantic engine for improving the search results by understanding the contextual meaning of the search query, thereby generating more relevant results.

According to an embodiment of the present invention, the system further comprises an information update service(s) for updating the overall score of each candidate according to chronological changes that occurs with respect to each candidate's profile.

### BRIEF DESCRIPTION OF THE DRAWINGS

In the drawings:

FIG. 1 schematically illustrates an intelligent job recruitment system in accordance with an embodiment of the present invention;

FIG. 2 is a flow chart generally illustrating a process performed by the intelligent job recruitment system in accordance with an embodiment of the present invention;

FIG. 3 schematically illustrates a web gadget plugin for interacting with the system, according to an embodiment of the present invention;

FIG. 4 schematically illustrates a semantic engine textual form, according to an embodiment of the present invention;

FIG. 5 schematically illustrates an example of search results, according to an embodiment of the present invention; and

FIG. 6 schematically illustrates an example for a Job Seeker Minipage, according to an embodiment of the present invention.

### DETAILED DESCRIPTION OF PREFERRED EMBODIMENTS

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

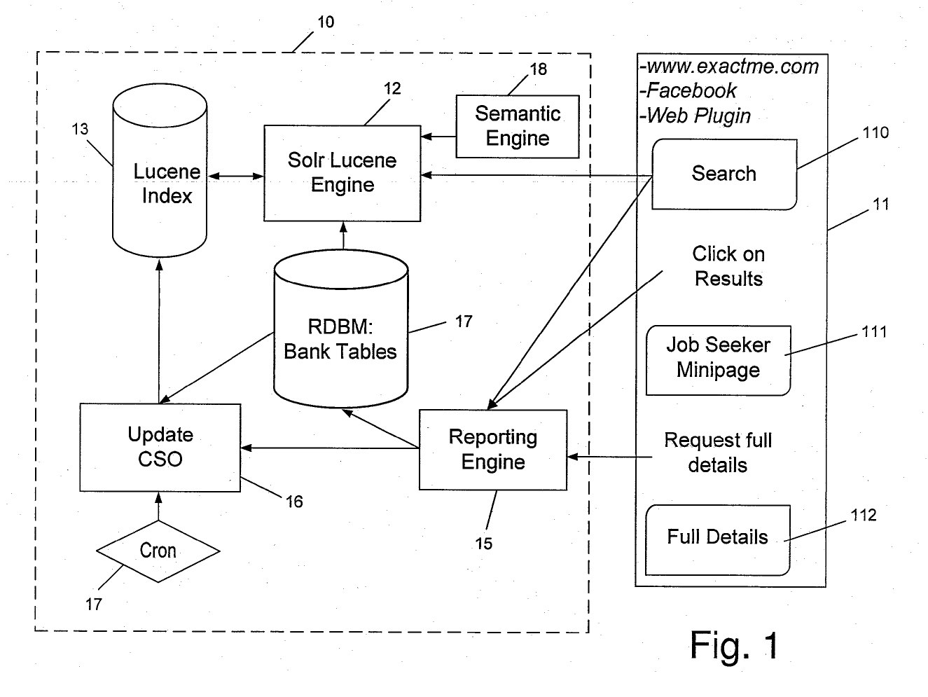

FIG. 1 schematically illustrates an embodiment of an intelligent job recruitment system 10, according to an embodiment of the present invention. System 10 finds and presents a list of candidates to a job recruiter based on the specific properties of each candidate, such as career goals, interests, and abilities and this with correlation to the web behavior of job hunters and employers regarding each specific candidate.

According to some embodiments of the invention, system 10 may also present the available job openings to a candidate in a manner that allows the candidate to easily determine the jobs he/she is most interested in. Furthermore, the system 10 determines a set of action items specific to the candidate to assist the candidate in reaching his/her specific career aspirations.

In one embodiment, system 10 comprises a computer-implemented program that provides probable job matches for its users (i.e., the job recruiters). The system 10 collects a variety of information about the candidates, including employment history, skills, geographic location, people the candidate knows, activities the candidate participates in, short and long-term desires and impressions (i.e., web behavior) of the candidate by other job recruiters. The system 10 collects this information directly from the candidate, from the candidate's peer group, and from the web behavior of previous job recruiters regarding that candidate within the system. Information about the candidate can also be collected through web sources outside of the system, including, for example, profiles of the candidate on other websites or secondary information about the candidate.

Information about the candidate is synthesized with internal and external data sets to provide the relevancy score of that candidate in order to match a specific job.

In one embodiment, system 10 comprises a search engine 12, a candidate profile index 13, a reporting engine 15, an update Career Search Optimization (CSO) module 16 and a relational database (RDBM) 17. Optionally, other modules, services, indexes or engines can also be used in system 10, such as an information update service (e.g., Cron 14), a semantic engine, a job description index, etc. Those of skill in the art will recognize that other embodiments can have different modules than the ones described here, and that the functionalities can be distributed among the modules in a different manner. In addition, the functions ascribed to the various modules can be performed by multiple engines.

Each of the various components (alternatively, modules) e.g., the search engine 12, the candidate profiles index 13 and the RDBM 17, is implemented as part of a computer system with one or more computers comprising a CPU, memory, network interface, peripheral interfaces, and other well known components. The computers themselves preferably run an operating system (e.g., LINUX), have CPUs, memory, and disk storage.

In this embodiment, the modules are stored on a computer readable storage device (e.g., hard disk), loaded into the memory, and executed by one or more processors included as part of the system 10. Alternatively, hardware or software modules may be stored elsewhere within the system 10. When configured to execute the various operations described herein, a general purpose computer becomes a particular computer, as understood by those of skill in the art, as the particular functions and data being stored by such a computer configure it in a manner different from its native capabilities as may be provided by its underlying operating system and hardware logic. It will be understood that the named components of the system 10 described herein represent one embodiment of the present invention, and other embodiments may include other components. In addition, other embodiments may lack components described herein and/or distribute the described functionality among the modules in a different manner. Additionally, the functionalities attributed to more than one component can be incorporated into a single component.

FIG. 1 also illustrates a client device 11 communicatively coupled to the system 10 over a provided network. The client device 11 can be any type of terminal unit that is capable of supporting a communications interface to the system 10. Suitable devices may include, but are not limited to, personal computers, mobile computers (e.g., notebook computers), personal digital assistants (PDAs), smart-phones, mobile phones, network-enabled viewing devices (e.g., set-top boxes). In this embodiment, only one client 11 is shown in FIG. 1 in order to simplify and clarify the description. In practice, plurality of clients 11 can connect to the system 10 via the provided network (e.g., via common internet protocols).

The network may be a wired or wireless network. Examples of the network include the Internet, an intranet, a WiFi network, a WiMAX network, a mobile telephone network, or a combination thereof. The method of communication between the client device 11 and the system 10 is not limited to any particular user interface or network protocol, but in a typical embodiment a user interacts with the system 10 via a conventional web browser of the client device 11, which employs standard Internet protocols.

The client 11 interacts with system 10 via any suitable computer platform (e.g., a common server) to find and present the relevant candidate information to the job recruiter. The computer platform provides controls and elements that allow a user to provide inputs to the system 10 for processing by the search engine 12 and for presenting information from the search engine 12 to the user. Typically, the computer platform presents the interface to the system 10 in the form of a website including one or more web pages with which the user can interact via a conventional web browser.

The candidate profiles index 13 comprises an index of profiles associated with different candidates of the system 10. Each profile includes information related to the candidate, and particularly, to the web behavior related to each candidate. Examples of information stored in a candidate profile can include a candidate's name, current job, jobs of interest, current location, locations of interest, specific career goals, employment history, skills, people the user knows, activities the user participates in, short and long-term desires, impressions about the user from others, etc.

The candidate profiles index 13 comprises a standardized index of job related information. Each entry candidate profiles index 13 comprises a set of fields describing a particular job such as a job title, a job description, a job level, experience, skills, and so on. According to some embodiments of the present invention, a job title of a candidate may explicitly include the job level within the title. For example, an entry level engineering job may be represented by a job title “Engineer 1”, while an experienced engineering job may be represented by a job title “Engineer 5”. In such embodiments, an entry may include both a primary job title, and a set of alternative job titles that each map to the primary job title. For example, a standard job title “Lawyer”, may have alternative job titles “Attorney” or “Legal Representative”. Additionally, each entry may also include a job description field. This field includes a text-based description of the typical responsibilities and skills of the candidate. Optionally, each entry can be translated and represented in other languages, thereby allowing to widening the use of system 10.

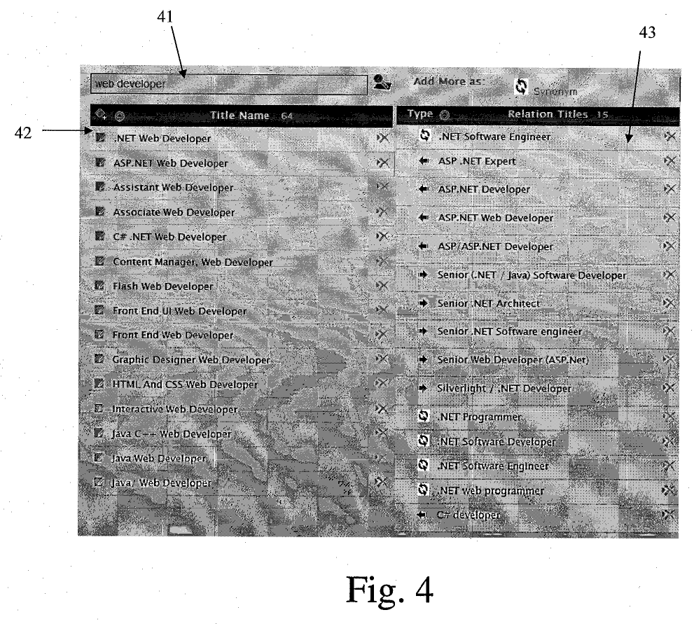

According to an embodiment of the present invention, system 10 may further comprise a semantic engine 18. Semantic engine 18 improves search results by understanding searcher (i.e., the job recruiter) intent and the contextual meaning of terms as they appear in the searchable field to generate more relevant results. For example, semantic engine 18 can operate according to the table shown in FIG. 4. In this example, a job recruiter is searching for a “web developer”. After typing the term “web developer” in the searchable field or dataspace as indicated by numeral 41, semantic engine 18 provides additional title names with the same meaning as the original typed term, such as “.net web developer” as indicated by numeral 42. In this example, the job title “.net web developer” has 16 relation titles (either synonyms or other alternative names) as listed in the right column 43.

According to an embodiment of the present invention, system 10 may further comprise an information update service(s) such as Cron 14 which used for updating the overall score of each candidate according to chronological changes that occurs with respect to each candidate's profile. For example, when a candidate starts a new job, gain an additional skill and the like.

In one embodiment, the candidate's profile also associates the candidate with ranking parameters stored in the RDBM 17. The ranking parameters reflect the relevancy of a candidate to a specific job. In this embodiment, the reporting engine 15 updates two tables in RDBM 17: 1) Skill-Skill Relevancy table (e.g., see Table 1); and 2) Skill-Industry rank table (e.g., see Table 2). When a candidate (i.e., a Job Seeker) profile is viewed (by a job Recruiter) then the CSO rank of that candidate (i.e., via the CSO update module 16) might be updated either directly by the reporting engine 15 or via the RDBM 17. When the relevancy and rank tables are updated, the CSO ranks of the Job Seekers must be recomputed. For example, the re-computation happens in regular intervals, as a background process.

The following is an example of a Skill-Skill Relevancy table:

TABLE 1

| Skill 1 | Skill 2 | Relevancy |
|---|---|---|
| Apache | PHP | 0.9 |
| Apache | C# | 0.1 |

The following is an example of a Skill-Industry Rank table:

TABLE 2

| Skill | Industry | Rank |
|---|---|---|
| Apache | Industry3 | 0.5 |
| Apache | Industry7 | 0.8 |

In one embodiment, the candidate's profile also includes a list of other individuals that are linked to the candidate through a social network. User's can link to each other within the system 10 to reflect a relationship through friendship, employer, professional area, schools attended, home location, or any other criteria linking the users together. Additionally, a user's profile can indicate social network relationships on external social networking sites such as, for example, facebook.com, myspace.com, linkedin.com, etc.

Optionally, system 10 may further comprise a job description index (not shown) which represents a standardized index of job descriptions. Each entry of the job description index comprises a set of fields describing a particular job such as a job title, a job description, a job level, salary statistics, experience required, skills required, and so on. Each entry also typically includes a job description field. This field includes a text-based description of the typical responsibilities and skills required for someone holding the job title.

### The Web Browser: Candidate Profile Creation

According to an embodiment of the invention, each job seeker can create a candidate profile via a dedicated client application (e.g., embedded within a website). The candidate profile may comprise the following information:
job related information, such as industry, job title, a list of skills in order of strength, etc.;
geographical location; and
educational level.

The candidate profile is submitted to system 10 (which also drives the website). For example, system 10 can use a Sol Lucene engine of The Apache Software Foundation. In such embodiment, system 10 converts each candidate profile into a Solr Lucene document and submits it to the Solr Lucene index (which represents the candidate profiles index 13).

The Solr Lucene index comprises an index of candidates. Additionally, the The Solr Lucene index can include candidates profile from corporate intranets and extranets, government databases, networking website such as Twitter.com, Facebook.com, Myspace.com, etc., or profiles directly uploaded to the system 10 by candidates.

Generally, the entries in the Solr Lucene index have multiple fields that are filled in by candidates when a candidate accesses the dedicated client application. Examples of fields can include title, description, experience, skills, and so on. The fields for each entry in the Solr Lucene index contain text as entered by a candidate.

Although the candidate profiles index 13 is illustrated as part of the system 10 for the sake of clarity and convenience, all or part of the index 13 can include data stored remotely from each other or remotely from other components of the system 10. For example, all or part of the candidate profiles index 13 can be stored on an external server that is remote from the server running the website. In one embodiment, remote indices are accessible by the web engine driving the website via an Application Program Interface (API) via a given network.

Those of skill in the art will recognize that other embodiments can have different modules than the ones described here, and that the functionalities can be distributed among the modules in a different manner. In addition, the functions ascribed to the various modules can be performed by multiple engines.

### The Web Browser: Search

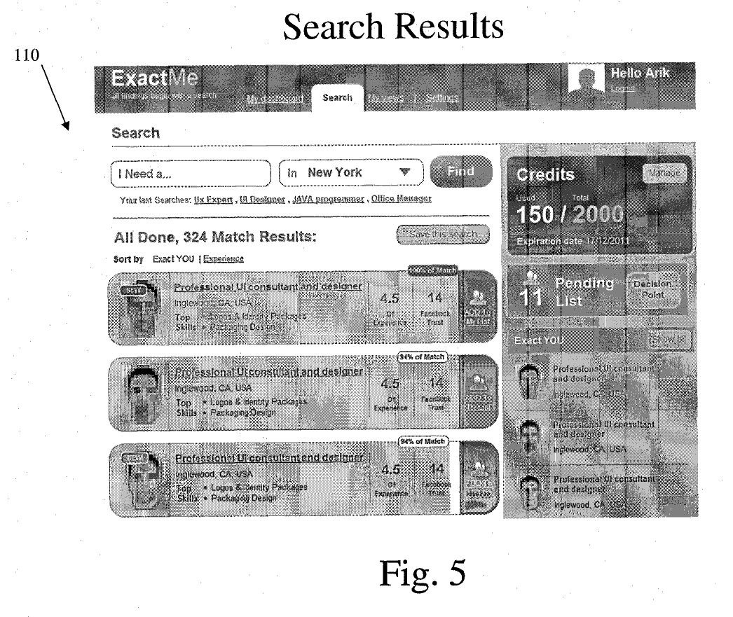

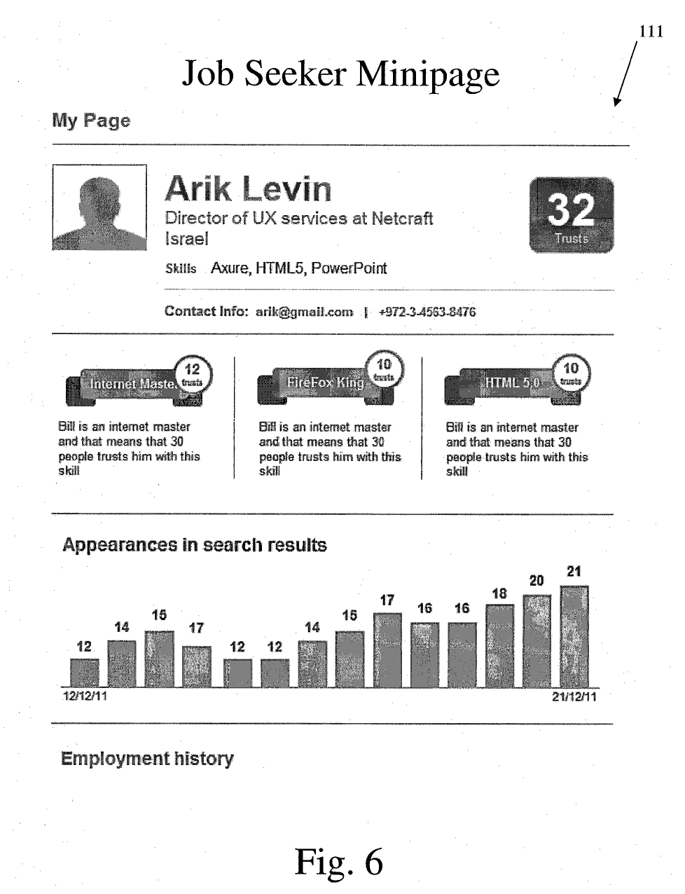

When a job recruiter logs into the system 10 and enters a query regarding a specific job title, the search engine 12 retrieves a list of candidate profiles from the candidate profiles index 13 (e.g., as shown with respect to FIG. 5). Using information in the profile, the search engine 12 performs an intelligent candidate hunt to find job seekers in candidate profiles index 13 that are relevant to the specific job query. For example, the search can be performed according to the following steps:
a) A search query is entered on the system's website by a job recruiter (as indicated by numeral 110 in FIG. 1 and as shown in FIG. 5);
b) A custom installation of a Solr search engine is queried with user supplied search;
c) In the background, a reporting engine 15 is notified that a query has been issued;
d) Results are displayed (e.g., see FIG. 5), listing all matching Job Seekers sorted according to relevancy (e.g., the relevancy can be ordered according CSO rank, job title, skills, etc.);
e) The job recruiter can click (i.e., select to view) on a job seeker of interest and inspect his profile. The selected job seeker profile is displayed to the job recruiter via the job seeker's Minipage (as indicated by numeral 111 in FIG. 1 and FIG. 6). The profile lists information such as the job seeker title and skills, CSO rank, etc. According to this example, at this step, part of the information remains unrevealed, such as the job seeker name and/or contact information;
f) If (step “e”) happens, then a notification is sent to the reporting engine 15 that such event has occurred (i.e., the job recruiter clicked on a specific job seeker of interest). This is used to update the candidate profile CTR (click-trough-ratio) of that specific job seeker;
g) Whenever the job recruiter chooses to view full details of the job seeker (i.e., request full details as indicated by numeral 112 in FIG. 1), a notification is sent to reporting engine 15. This is also used to update the candidate profile CTR (click-through-ratio).

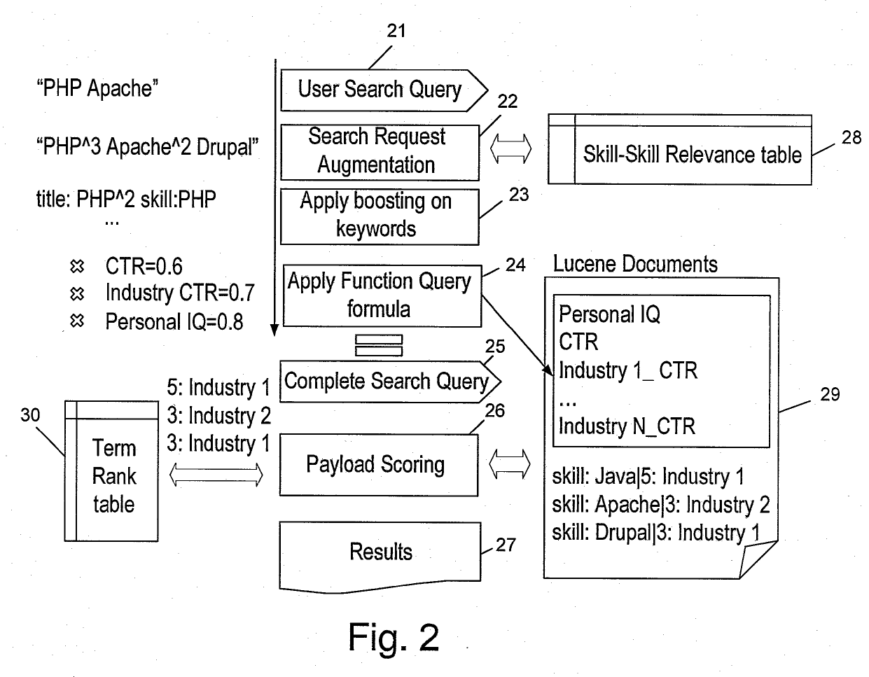

The search engine 12 automates a search of the candidate profiles index 13 to return a list of candidates relevant to a particular job. The retrieved list of candidates is filtered and sorted according their relevancy to one or more categories (e.g., Personal IQ, CTR, Industry CTR, etc.) to present the information in a manner useful to the job recruiter. An example of a process performed by the search engine 12 and the update CSO module 16 is described with respect to the flowchart of FIG. 2 described in more detail herein below.

The categories determine the relevancy scores indicative of the candidate's matching level for a particular job. The update CSO module 16 analyzes various candidate web behaviors and dynamically updates the job candidate relevancy scores, as will be described in more detail below with reference to FIG. 2.

FIG. 2 illustrates an example embodiment of a search process performed by the system 10, according to an embodiment of the present invention. For example, the search process may comprise the following steps:

At first, block 21, the search engine receives a search string “a1 a2 a3 . . . ” by a job recruiter in a specific industry field (e.g., IndustryK), together with recruiters preferred location.

At the next step, blocks 22, two relevant skills are added to the search query, by looking up Skill-Skill relevancy table (block 28), for example, with the following pseudo code SQL query: “select top 2*from T where skill=a1 or skill=a2 or skill=a3 . . . order by decreasing relevancy”.

At the next step, block 23, system 10 applies boosting on keywords in the query according to their order in the query string. For example, words at the beginning of the query have more weight than words at the end of the query. For example, the searches “C# Java” and “Java C#” will not yield the same results. In the first case C# developers are scored higher than Java developers, in the second case, it is vice versa. Additionally, system 10 applies boosting on keywords according to type of field. For example, match of a keyword in a title has twice more weight than a match of a keyword in a skill field.

At the next step, block 24, the search engine 12 applies Function Query formula (e.g., from Lucene documents format—block 29) in order to incorporate CTR, CSO (i.e., Personal IQ), location information, and education level.

At the next step, block 25, the query is completed (i.e., the query is completely built with the parameters required for performing a search for candidates regarding the job query as provided by the job recruiter).

After the query is built, at the next step, block 26, the searching operation begins by the search engine 12. The search incorporates matching over the skills and titles by scoring the payloads which represent the skill strength and skill industry rank. Each payload for a skill S consists of a pair strength:IndustryJ (indicated by blocks 29 and 30). The Skill relevancy table is looked up for IndustryJ and skill S. The score for the payload is thus the product of strength and the skill rank for this industry. At the next step, block 27, the search results are returned. The output of the searching step (block 27) is a pool of candidates which are relevant to the specific job entered for searching.

The search engine 12 queries the candidate profile index 13 using, for example, a textual query related to the job title or field (e.g., “patent attorney”). Alternatively, the search engine 12 can query using codes representative of the job groups (e.g., O*NET-SOC codes). In one embodiment, the query also limits the set of search results to candidates in a particular geographic area (e.g., within 50 Km of a specified zip codes). The search engine 12 can automatically determine one or more geographic areas of interest to the job recruiter based on information in the candidate's profile.

In one embodiment, the search engine 12 maps the provided job query to an entry in the candidate profile index 13 using a conventional pattern matching or word matching algorithm, such as, for example, the Solr open source enterprise search platform from the Apache Lucene project. The matching algorithm outputs a matching score representing the strength of the match between a particular built job query and an entry in the candidate profile index 13.

The search engine 12 next sorts the pool of candidates according to one or more relevancy parameters. A relevancy parameter represents a particular way to filter and/or sort the candidates based on one or more goals. In particularly, based on the web behavior of other job recruiter regarding a specific candidate, such as information regarding whether the candidate's profile viewed and/or selected by other job recruiter (this is done by the reporting engine 15). For example, a higher score may be assigned to candidates in a manner that gives greater weight to candidates that their profile was viewed by other job recruiter. Additionally, other category parameters may sort candidates to provide greater weight to candidates that are at least one job level higher than other suitable candidates. Other types of category filters can sort the results according to different weighting criteria as will be apparent to those of ordinary skill in the art.

In one embodiment, the system 10 may determine a probability of the candidate being qualified for a particular job opening and presents the probability together with the sorted results. In this embodiment, the engine 12 can use information from the candidate's relevancy scores and other information in the candidate's profile to model the candidate's chance.

According to an embodiment of the present invention, each of the relevancy scores is calculated according to each specific job query. Thus, a specific candidate could be sorted differently, for each specific job query. According to different category filters, any number of relevancy scores can be computed, each associated with a different target job. Additionally, different target job criteria can be used depending on the particular goals of the job query. An overall score for each candidate listing is determined by weighting and summing the relevancy scores. The weights of the relevancy scores depend on the particular job being queried. Those of ordinary skill in the art will recognize that other category for relevancy calculation can be applied to present a different sorting of the candidates according to varying objectives.

The reporting engine 15 determines an updated selection of candidates. A dynamic update is applied to reflect these changes. For example, in one embodiment, job recruiter actions such as marking a candidate or viewing a candidate may increase the overall relevancy score for that candidate in the sorted lists. Conversely, actions such as ignoring a candidate, may decrease the overall relevancy score for that candidate in the sorted list, or may eliminate the appearing of that candidate from the sorted list entirely.

In one embodiment, the system 10 can also analyze user interactions from other sources using a dedicated application, such as an integrated web-based application for social network. For example, the system 10 can analyze information from other web-based services such as social networking services (e.g., Facebook™, Linkedin™, MySpace™, etc). System 10 can also analyze information pertaining to the job seeker's interpersonal skills or job skills such as, for example, the job seeker's experience with a specific computer language or the job seeker's ability to speak in public. Other information already included in the job seeker's social network profile can also be analyzed for this purpose.

In some embodiments of the invention system 10 can output search results (i.e., an ordered list of matching candidate profiles) to a social network. In this context, social network means any network reflecting social relationships, and includes, without limitation, online social networks (e.g., Facebook™, Linkedin™, MySpace™, on-line email accounts, etc.)

Such dedicated application may interface and/or communicate with various social networks via server-side process, client-side, or another process, in order to exchange information such as professional and other information. For example, the dedicated application may interface and/or communicate with social networks such as Facebook™ or Linkedin™ to obtain or provide information by a job-seeker using a personal Job Seeker Minipage. The Job Seeker Minipage can be generated to the user by using the dedicated application via the user social network profile. The dedicated application may further obtain candidate skill level and behavioral characteristic level information about candidates, such as those described above, from social networks. The dedicated application may also obtain position information from various social networks, such as employers with open positions, and requirements of those open positions. FIG. 6 schematically illustrates an example for such a Job Seeker Minipage 111, according to an embodiment of the present invention. In this example, a part of a minipage 111 of a job seeker named “Arik Levin” is shown. The minipage is a webpage which includes information related to the specific job seeker, such as job title (e.g., “Director of UX services at Netcraft”), contact information, skills (e.g., Axure, HTML 5.0, PowerPoint), number of trusts for each specific skill (e.g., 32 trusts in total, wherein 12 trusts are provided for being an Internet Master, 10 trusts for being FireFox “King”, and 10 trusts for being an HTML 5.0 expert), appearance in search results, employment history, and other information.

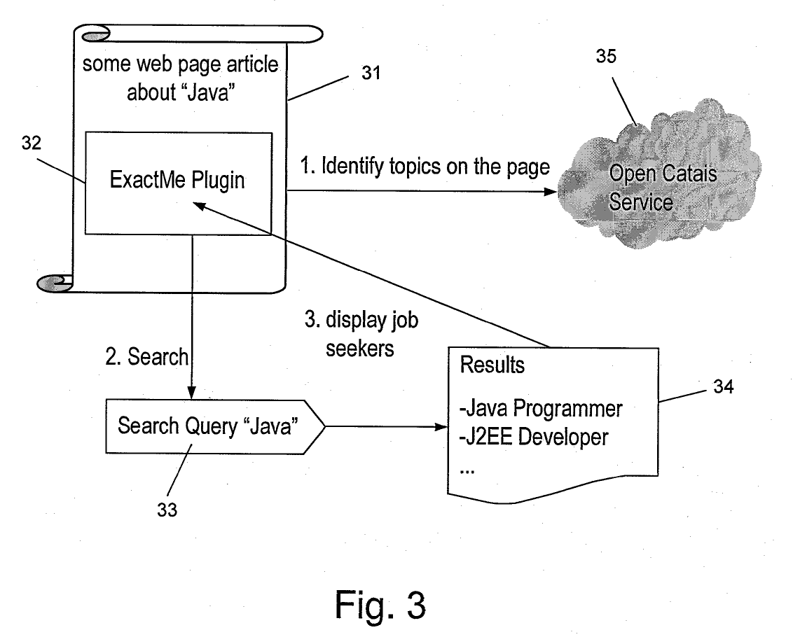

FIG. 3 schematically illustrates a web gadget plugin 32 for providing one or more candidates based on the operation of system 10, according to an embodiment of the present invention. The web gadget plugin 32 is similar to Google AdSense, however, instead of advertisements about topics on a page, it shows Job Seekers matching topics or context on the page. For example, if a given webpage is about J2EE, it will show “Java developer” job seekers.

For example, the operation of plugin 32 can be as follows:
1. Tomphson Reuters “OpenCalais” web-service 35 is contacted by plugin 32 to retrieve a list of topics for a given webpage (e.g., webpage article about Java 31);
2. The list of topics is submitted as keywords into the search engine 33 associated with plugin 32 (which is similar to search engine 12); and
3. Top three job seekers are displayed 34 in the gadget plugin 32. Clicking on one of the job seekers open his personal profile on the website associated with system 10.

Beneficially, system 10 finds and presents a list of suitable candidates or job seekers that are relevant to a specific job opening. Thus, the system 10 allows the job recruiter to easily obtain the most suitable candidates in a simplify job hunting process.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the media host service may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. All such process steps, instructions or algorithms are executed by computing devices that include some form of processing unit (e.g., a microprocessor, microcontroller, dedicated logic circuit or the like) as well as a memory (RAM, ROM, or the like), and input/output devices as appropriate for receiving or providing data.

The present invention also relates to a system for performing the operations herein. This system may be specially constructed for the required purposes, or it may comprise a general-purpose computer selectively activated or reconfigured by a computer program stored in the computer, in which event the general-purpose computer is structurally and functionally equivalent to a specific computer dedicated to performing the functions and operations described herein. A computer program that embodies computer executable data (e.g. program code and data) is stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for persistently storing electronically coded instructions. It should be further noted that such computer programs by nature of their existence as data stored in a physical medium by alterations of such medium, such as alterations or variations in the physical structure and/or properties (e.g., electrical, optical, mechanical, magnetic, chemical properties) of the medium, are not abstract ideas or concepts or representations per se, but instead are physical artifacts produced by physical processes that transform a physical medium from one state to another state (e.g., a change in the electrical charge, or a change in magnetic polarity) in order to persistently store the computer program in the medium. Furthermore, the computers referred to in the specification may include a single processor or may be architectures employing multiple processor designs for increased computing capability.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A computer-implemented method for sorting candidates according to their relevance to a job query, comprising the steps of:
a. Providing an interface through which a search for candidates can be executed;
b. Storing in a candidate profile index information related to each candidate, wherein said index have multiple types of fields that includes skills and titles;
c. Upon supplying a search query trough said website, search engine is queried with said supplied query, wherein said query includes one or more keywords;
d. Providing a reporting engine for notifying whenever said search query has been issued;
e. Automatically building a full search query according to said search query by boosting said keywords according to their order in said query and type of field;
f. Matching between said full search query and said stored candidates' profiles, wherein said matching incorporates matching over candidate's skills and titles by scoring payloads which represent skill strength and skill industry rank, wherein each payload for a specific skill consists a pair of strength and industry, such that the score for the payload is thus the product of strength and skill rank for said industry;
g. Displaying, listing of all matching candidates sorted according to their relevance to said full search query; and
h. Whenever selecting a candidate profile from said listing, sending a notification to the reporting engine for updating an overall score of said selected candidate.

2. A method according to claim 1, wherein the boosting of the keywords is done by a semantic engine which used for improving the search results by understanding searcher intent and the contextual meaning of the search query, thereby generating more relevant results.

3. A method according to claim 1, further comprising providing an information update service(s) for updating the overall score of each candidate according to chronological changes that occurs with respect to each candidate's profile.

4. A method according to claim 1, wherein the search engine is a custom installation of a Solr search engine.

5. A method according to claim 1, wherein the search engine queries the candidate profile index using data selected from the group consisting of textual query related to the job title or field, codes representative of the job groups, geographic area, or combination thereof.

6. A method according to claim 1, wherein the search query limits the search results to candidates in a particular geographic area, wherein the search engine can automatically determine one or more geographic areas of interest to the searcher based on information in the candidate's profile.

7. A method according to claim 1, wherein the search engine maps the search query to an entry in the candidate's profile index using a pattern matching or word matching algorithm, which is capable of outputting or providing a matching score representing the strength of the match between a particular built job query and an entry in said candidate profile index.

8. A method according to claim 1, wherein the search engine sorts the search results according to relevancy score being currently calculated for a specific search query, wherein said relevancy score is being calculated according to one or more relevancy parameters, thus the overall score for each candidate listing in said results is determined by weighting and summing the relevancy scores, and wherein the weights of the relevancy scores depend on the particular job being queried.

9. A method according to claim 8, wherein at least on of the relevancy parameters is based on the overall score of each candidate which reflects the web behavior of other job recruiter with respect to a specific candidate profile, whether said specific candidate's profile viewed and/or selected by other job recruiter.

10. A method according to claim 1, further comprising determining a probability of the candidate being qualified for a particular job opening and presents the probability together with the search results.

11. A method according to claim 8, wherein each of the relevancy scores is calculated according to each specific search query, thus a specific candidate could be sorted differently, for each specific job query. According to different category filters, any number of relevancy scores can be computed, each associated with a different target job. Additionally, different target job criteria can be used depending on the particular goals of the job query.

12. A method according to claim 1, further comprising analyzing candidate interactions from other sources using a dedicated application.

13. A method according to claim 12, wherein the dedicated application is an integrated web-based application for social network, thereby allowing said system to output search results to a social network and/or obtain candidate information from said social networks.

14. A method according to claim 1, further comprising providing a web gadget plugin showing Job Seekers matching topics or context on a webpage.

15. A system for sorting candidates according to their relevance to a job query, comprising:
a. a web server for providing an interface through which a search for candidates can be executed;
b. a candidate profile index for storing information related to each of said candidates;
c. a search engine for analyzing a search query provided from said interface, wherein said search query includes one or more keywords and for automatically building a full search query according to said search query by boosting said keywords according to their order in said query and type of field, for matching between said full search query and said stored candidates' profiles, wherein said matching incorporates matching over candidate's skills and titles by scoring payloads which represent skill strength and skill industry rank, wherein each payload for a specific skill consists a pair of strength and industry, such that the score for the payload is thus the product of strength and skill rank for said industry, and accordingly for generating a listing of all matching candidates sorted according to their relevance to said full search query; and
d. a reporting engine for updating an overall score of each candidate whenever a candidate profile is selected from said listing.

16. A system according to claim 15, further comprising a semantic engine for improving the search results by understanding the contextual meaning of the search query, thereby generating more relevant results.

17. A system according to claim 15, further comprising an information update service(s) for updating the overall score of each candidate according to chronological changes that occurs with respect to each candidate's profile.

18. A system according to claim 15, further comprising a web gadget plugin for showing Job Seekers matching topics or context on a webpage.
